(19) United States
(12) Patent Application Publication
(10) Pub. No.: US 2023/0051596 A1
(43) Pub. Date: Feb. 16, 2023

(54) PRINTER MODIFICATION SYSTEM FOR ELECTIONS DOCUMENTS

(71) Applicant: Runbeck Election Services, Inc., Phoenix, AZ (US)

(72) Inventor: Robert Dandurand, Phoenix, AZ (US)

(21) Appl. No.: 17/887,329

(22) Filed: Aug. 12, 2022

Related U.S. Application Data
(60) Provisional application No. 63/232,510, filed on Aug. 12, 2021.

(51) Int. Cl. B65H 1/26; B41J 13/10

(52) U.S. Cl. CPC B65H 1/266; B41J 13/106

(57) ABSTRACT

Various embodiments of a printer modification system for modifying a printer to accommodate different sized documents such as elections documents are disclosed herein.

### CROSS REFERENCE TO RELATED APPLICATIONS

This is a non-provisional application that claims benefit to U.S. Provisional Application Ser. No. 63/232,510, filed on Aug. 12, 2021, which is herein incorporated by reference in its entirety.

### FIELD

The present disclosure generally relates to print devices and associated components; and in particular, to an improved system and associated methods for printing elections documents.

### BACKGROUND

Election ballot printing systems are commonly required by law to adhere to various paper and printing regulations that can be considered nonstandard for most consumer printing preferences. However, general printing systems with conventional printing devices are presently limited by specific paper size capabilities of standard feed compartments and associated components. As such, conventional printing technologies may be insufficient for mass print jobs for different documents such as elections documents that have unique and often larger dimensions.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a photograph of a printer modified by a system described herein; the printer as modified being improved and equipped to process documents the printer would not be capable of processing (e.g., elections documents) prior to modification by the system.

FIG. 1B is a photograph of the printer in FIG. 1A in a pre-modified configuration prior to application of the system.

FIG. 2A is a perspective view showing the system of FIG. 1A separated from the printer; the system including an input assembly for feeding the documents, and an output assembly including an output extension for securing/resting the documents along the printer during/after a print job.

FIG. 2B is a rear view of the system of FIG. 2A prior to engagement with the printer.

FIG. 2C is a front view of the system of FIG. 2A prior to engagement with the printer.

FIG. 2D is a side view of the system of FIG. 2A prior to engagement with the printer.

FIG. 2E is another side view of the system described herein prior to engagement with the printer.

FIG. 2F is a top view of the system described herein prior to engagement with the printer.

FIG. 2G is a bottom view of the system described herein prior to engagement with the printer.

FIG. 3A is an illustration of a perspective view of the input assembly of the system described herein prior to engagement with the printer.

FIG. 3B is a top view of the input assembly.

FIG. 3C is a photograph illustrating a perspective view of the input assembly.

FIG. 3D is a photograph illustrating further details related to a paper stop of the input assembly and an associated adjustment mechanism.

FIG. 3E is a photograph illustrating the printer's stock feed compartment exposed by removing the feed cover from the printer.

FIG. 3F is a photograph of the printer with the printer's stock feed compartment removed, exposing a limited housing of the printer.

FIG. 3G is a photograph illustrating engagement of the input assembly to the printer's stock feed compartment (temporarily removed from the printer).

FIG. 3H is a photograph of a latch defined along the feed compartment of the printer.

FIG. 3I is a photograph of a notch formed along a bottom side of the input extension of the input assembly that engages the latch of FIG. 3H.

FIG. 4A is a perspective view of the output assembly of the system of FIG. 2A.

FIG. 4B is a photograph illustrating the printer engaged to the output assembly.

FIG. 4C is a photograph illustrating additional details of the output assembly including connection components for mounting the output assembly to the printer.

FIG. 4D is a photograph illustrating additional details for mounting the output assembly to the printer.

FIG. 4E is a photograph illustrating a front view of the output assembly mounted to the printer to accommodate larger documents (e.g., elections documents).

FIG. 5 is a simplified block diagram illustrating a method of forming an input assembly and an output assembly as described herein for modifying a printer.

FIG. 6 is a simplified block diagram illustrating a method for implementing the system described herein to modify a printer.

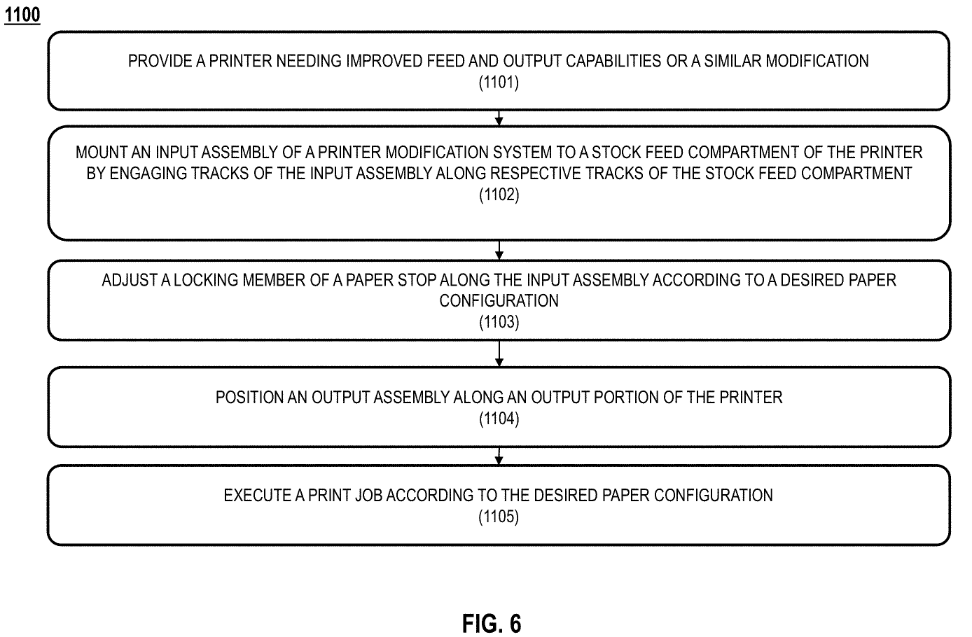

Corresponding reference characters indicate corresponding elements among the view of the drawings. The headings used in the figures do not limit the scope of the claims.

### DETAILED DESCRIPTION

Various embodiments of a system and associated methods for modifying a printer to accommodate different documents such as elections documents are described herein. In a first embodiment, the system includes an input assembly that configures a printer to feed or input various documents for printing, such as elections documents or simply larger documents for a print job. In other words, the input assembly modifies the printer to feed or input documents that the printer would otherwise be incapable of feeding or printing for whatever reason. In general, the input assembly includes an input tray and an extension member that engages with a stock feed compartment of the printer, and a paper stop in communication with the input tray that is adjustable to accommodate different document types and sizes. In addition, the system includes an output assembly that engages to an output portion of the printer for securing the elections documents during and/or after the print job, including a delivery extension member.

In a second embodiment, the system includes the input assembly of the first embodiment, but the system of the second embodiment is devoid of the output assembly. In a third embodiment, the system includes the output assembly of the first embodiment, but the third embodiment is devoid of the input assembly of the first embodiment. Other embodiments and related components are contemplated. The present novel concept is intended to modify an OKI™ printer, such as the OKI B432dn, or a similar OKI printer or any similar non-OKI printer. However, while references to particular printer devices are made in the following description, it should be appreciated that the novel concepts described herein may be applied to other printers or print devices without departing from the spirit and scope of the present inventive concept.

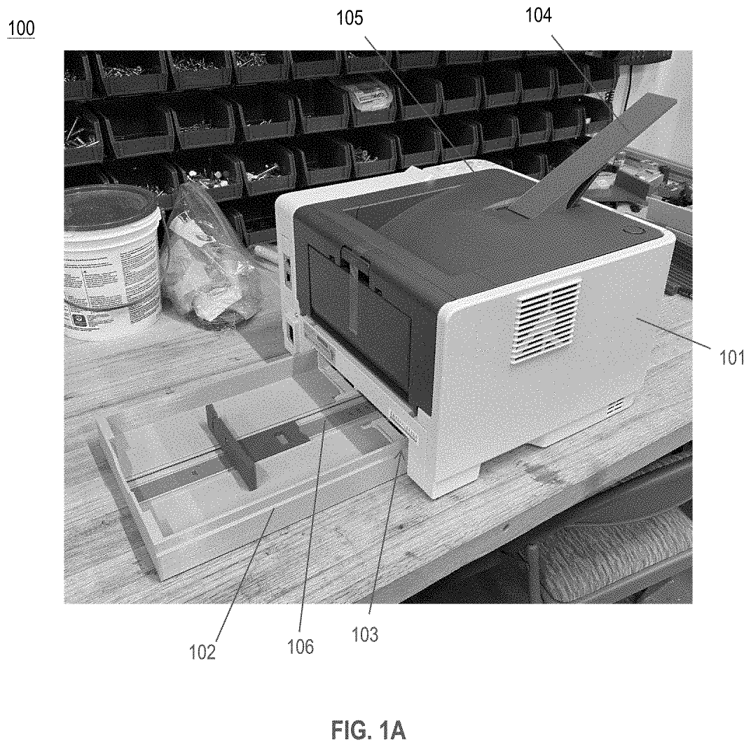

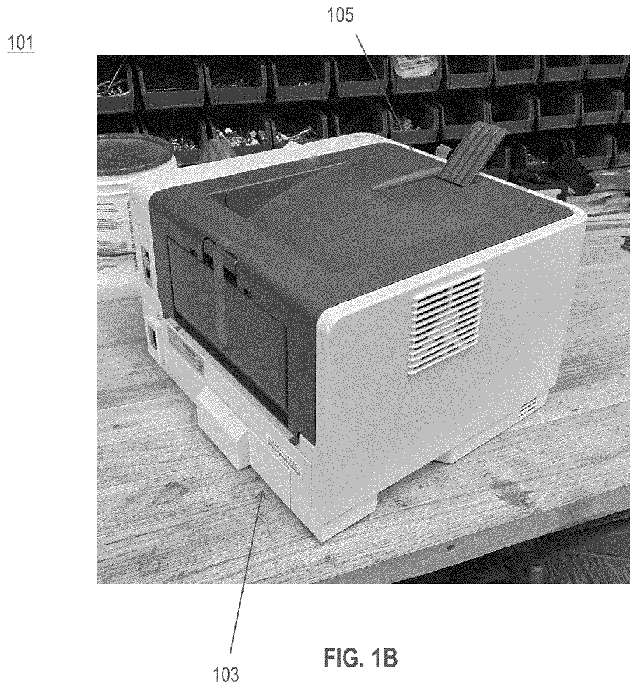

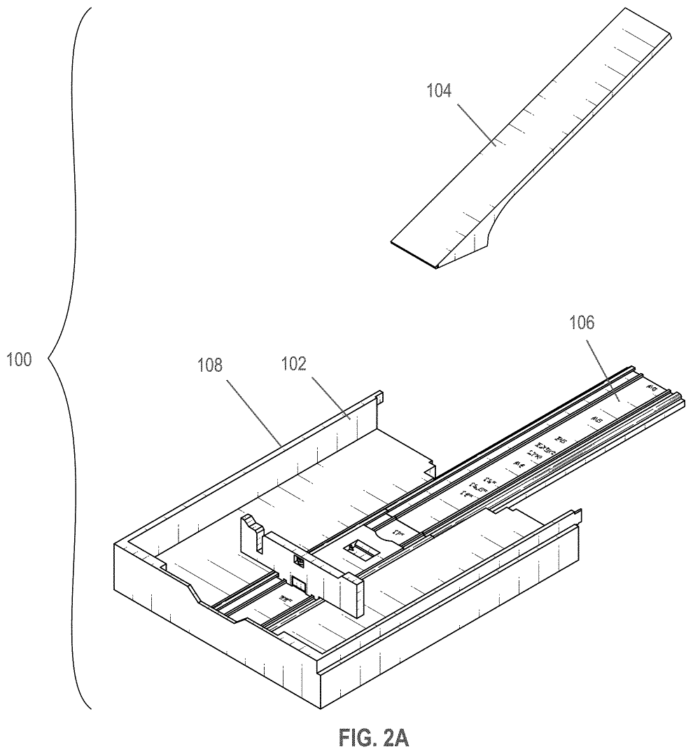

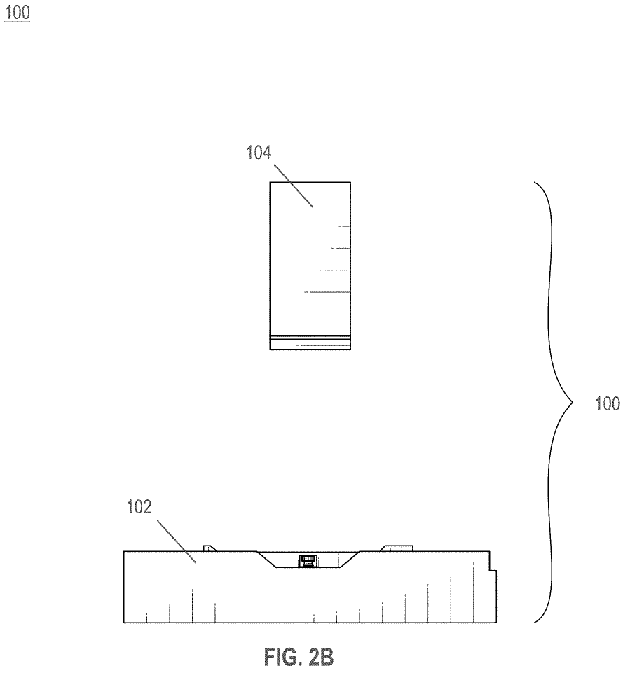

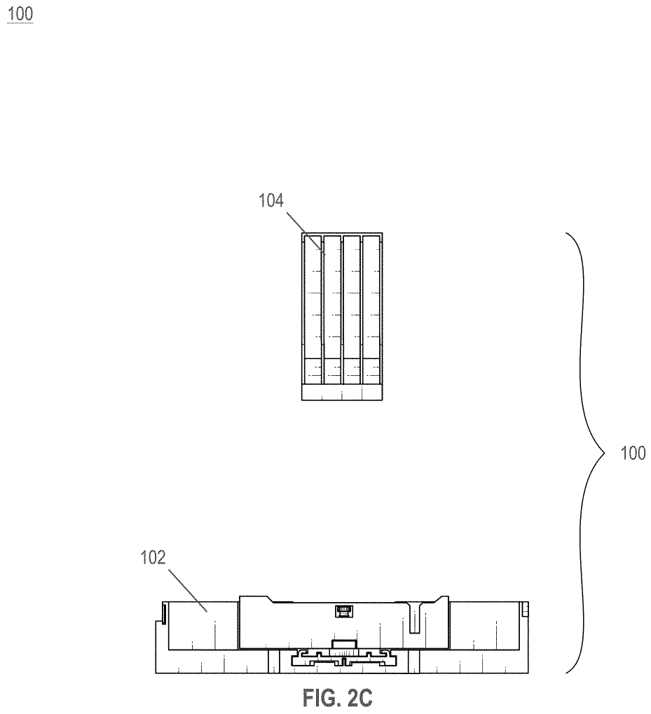

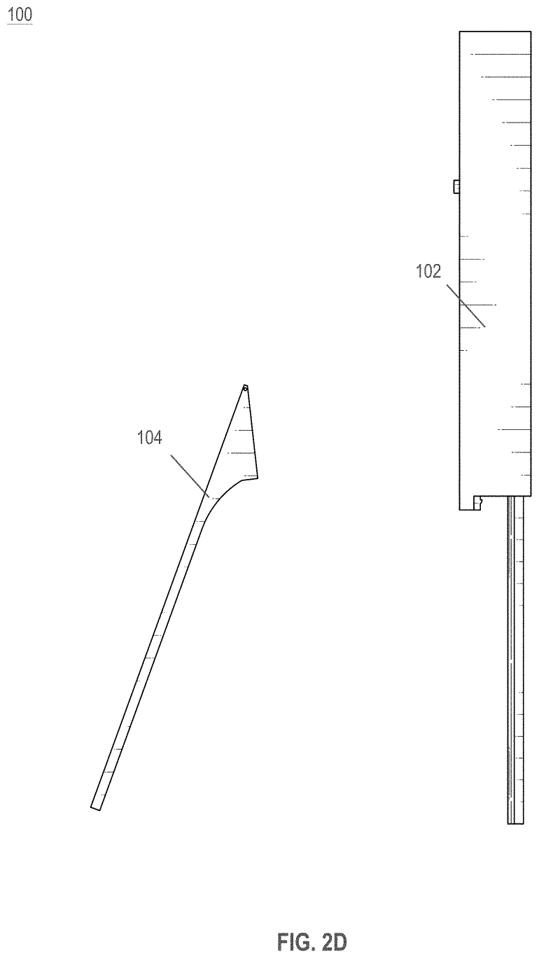

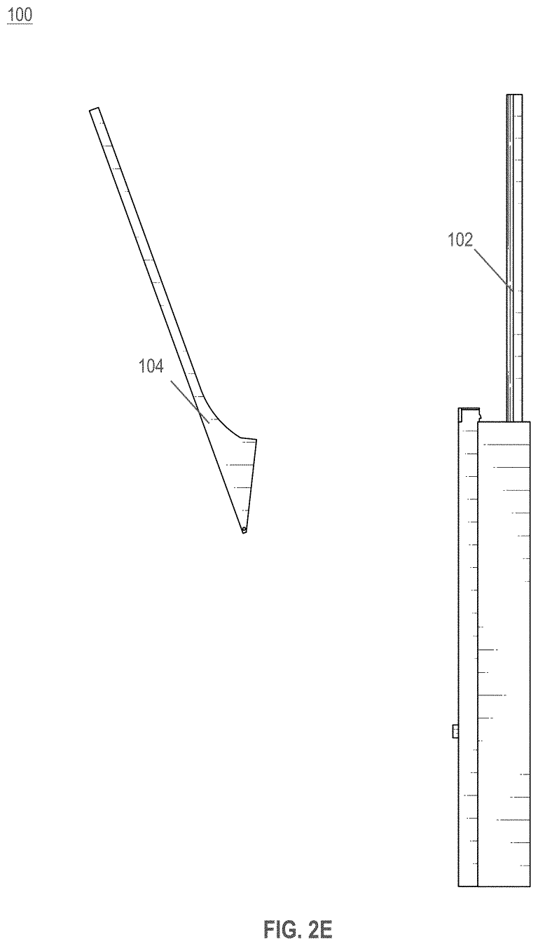

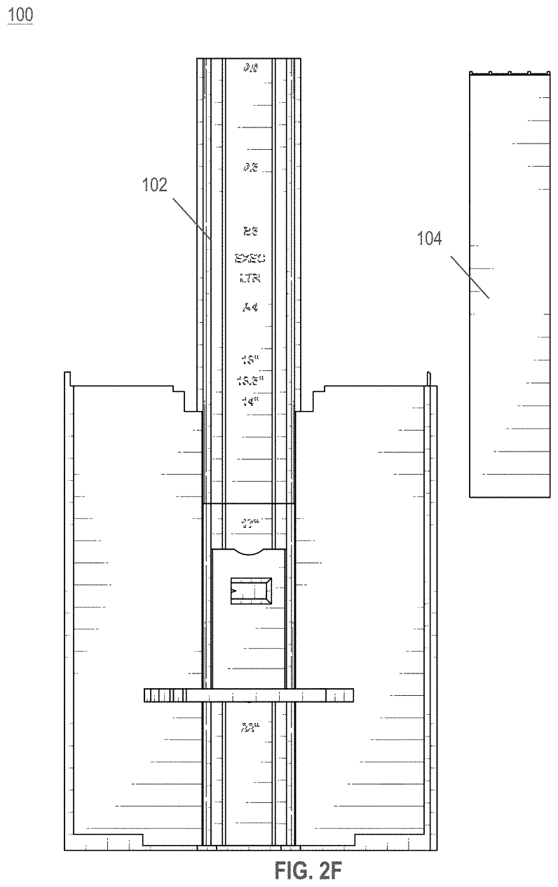

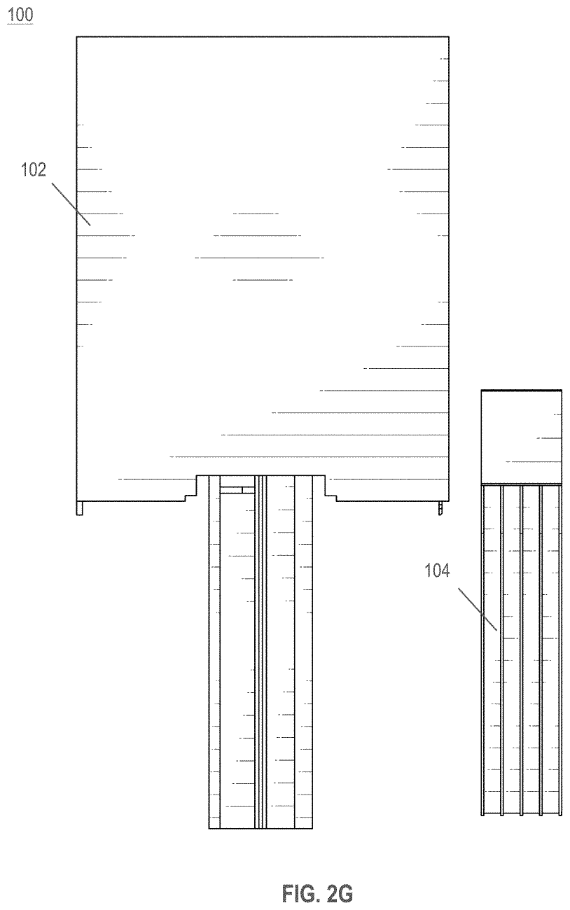

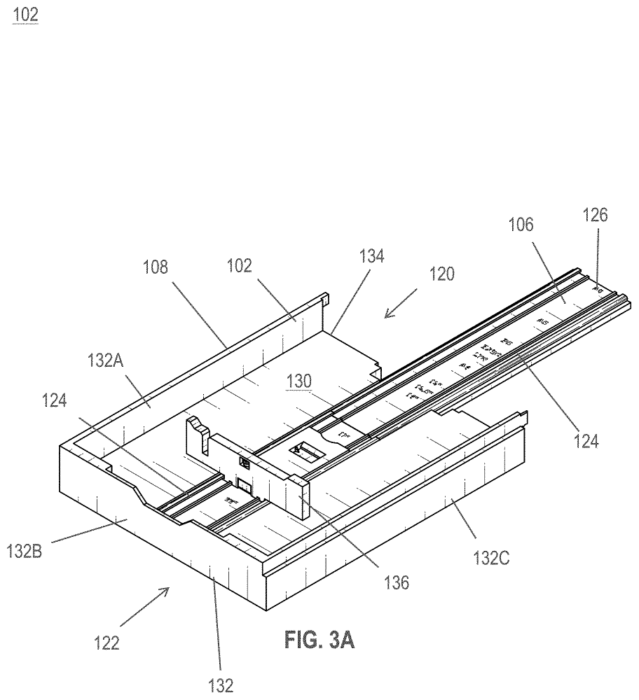

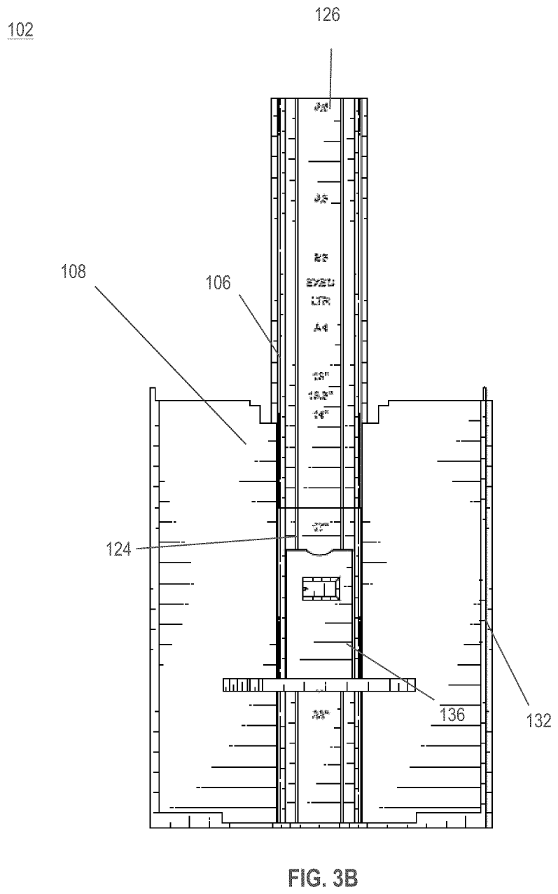

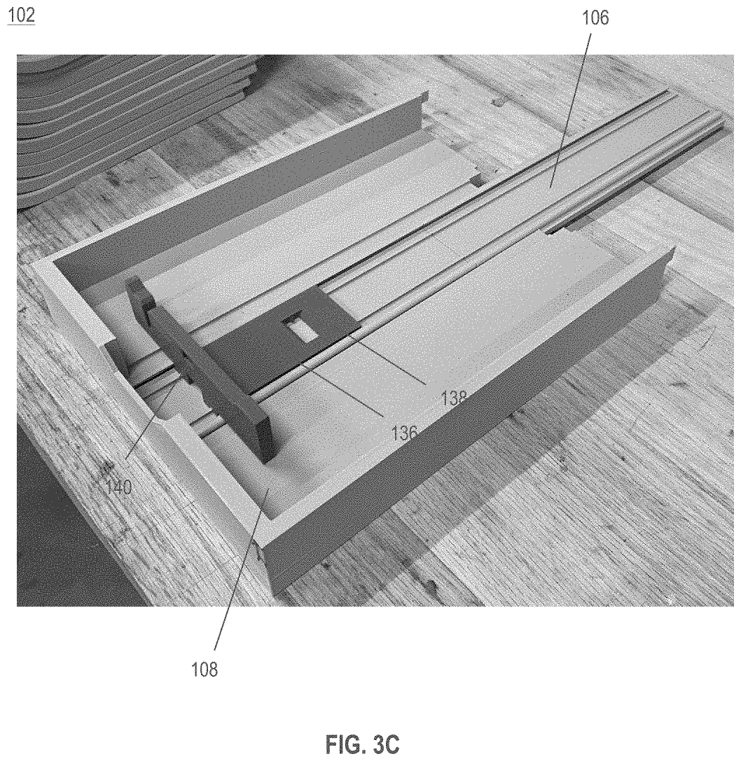

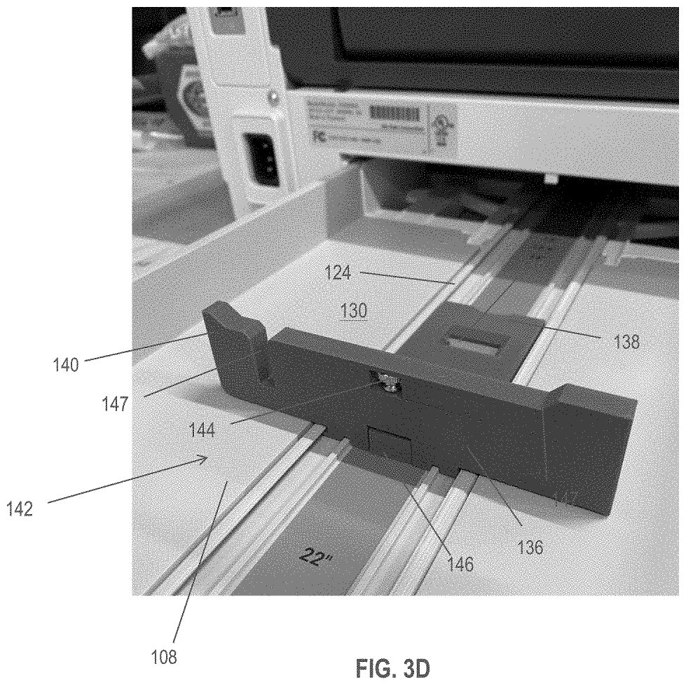

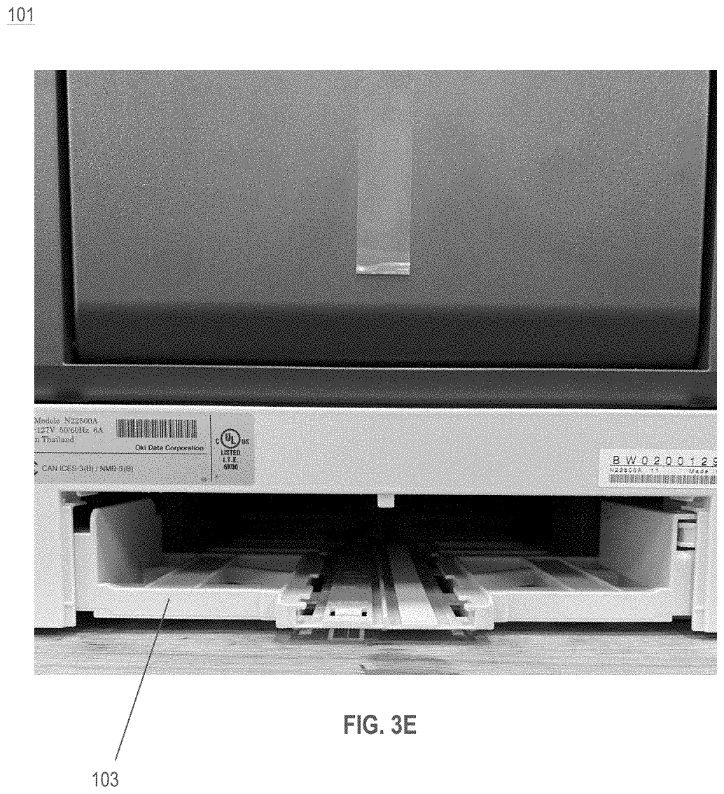

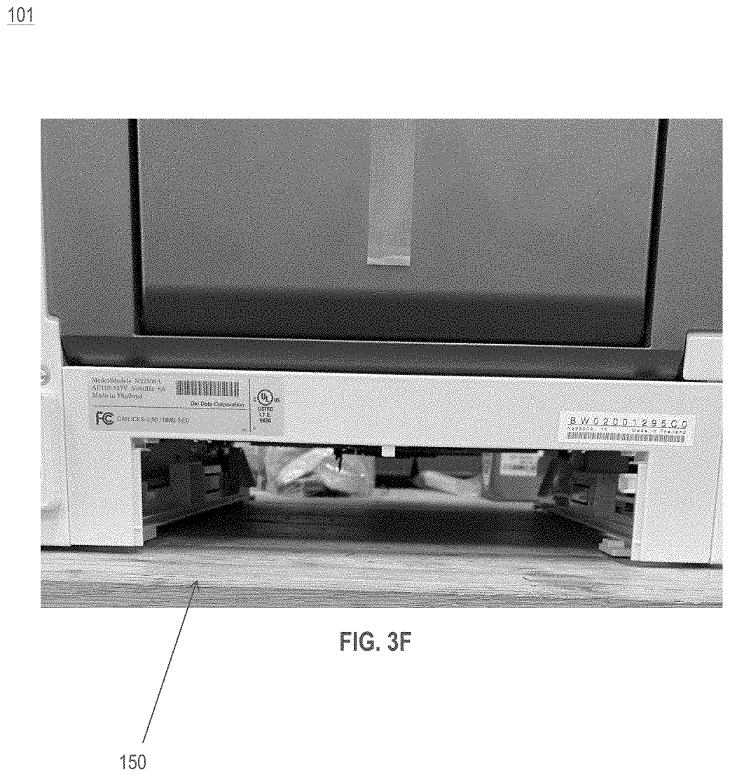

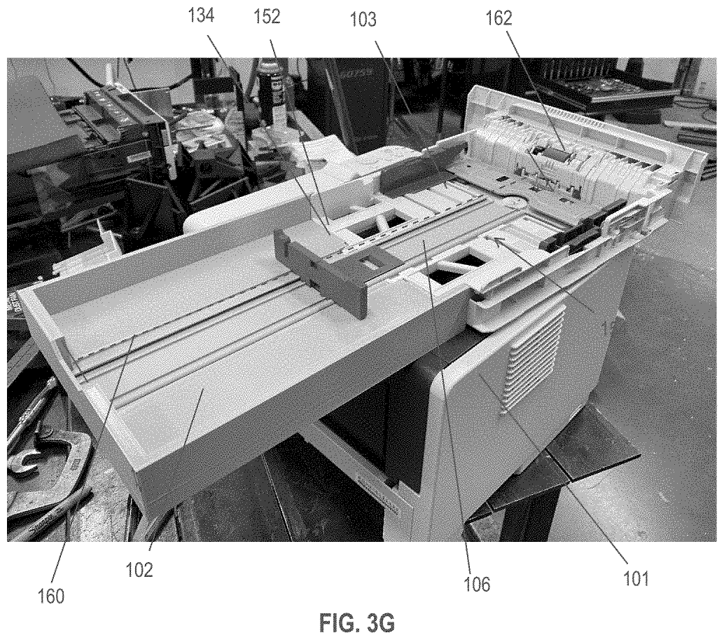

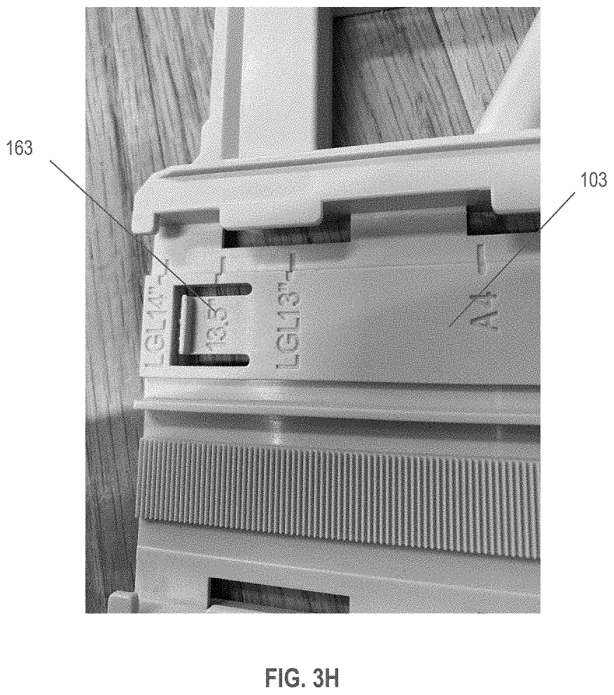

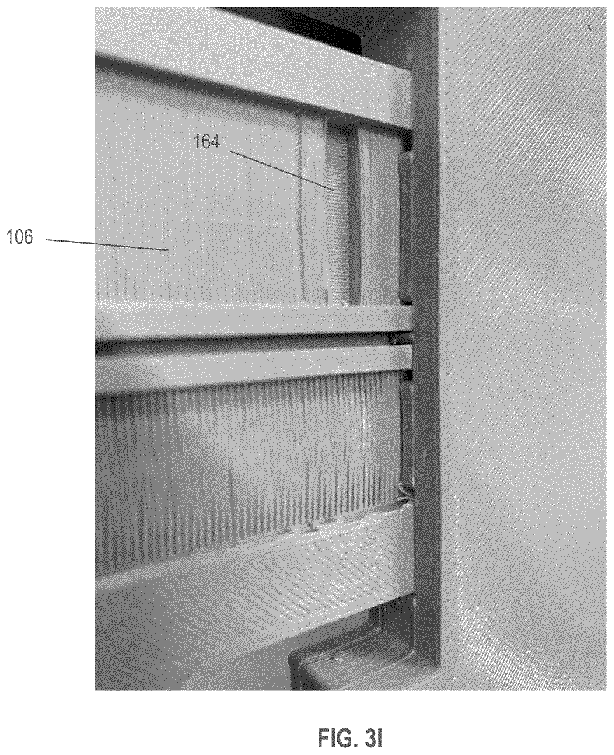

Referring to FIGS. 1A-1B and FIGS. 2A-2G, an embodiment of a system 100 for modifying a printer 101 to accommodate different documents is illustrated. In general, the system 100 includes an input assembly 102 that modifies the printer 101 such that the printer 101 is capable of feeding or otherwise inputting documents (e.g., elections documents such as ballots) that the printer 101 would otherwise be incapable of feeding or printing for whatever reason. As indicated in FIG. 2A, an input extension 106, extending from a substrate defined as an input tray 108 of the input assembly 102 connects or otherwise engages with a (stock) feed compartment 103 of the printer (FIG. 1A and FIG. 3E). The feed compartment 103 (shown in greater detail in FIG. 3E) defines a general housing for feeding general documents to printing components of the printer 101; and without the input assembly 102, lacks features for accommodating the input of various larger or different documents such as elections documents. In general, the input assembly 102 engages with the feed compartment 103 and increases the dimensions of the housing of the printer 101 so that larger/different documents can be fed to the printer 101 securely and efficiently.

In addition, the system 100 includes an output assembly 104 that engages to an output portion 105 of the printer for securing the documents during and/or after the print job. The output assembly 104 as shown in FIG. 1A generally defines an elongated member (delivery extension) that connects with the output portion 105 at an angle to so that printed documents can be stacked securely along the output assembly 104 during a print job. In general, the output assembly 104 provides a greater surface area beyond the general footprint of the printer 101 for documents to rest after printing.

Referring to FIGS. 3A-3G, additional details associated with the input assembly 102 of the system 100 are illustrated. As indicated, the input extension 106 extends from a general centermost portion of the front side 120 of the input tray 108, opposite a back side 122. The input assembly 102 includes a plurality of tracks 124 or grooves formed longitudinally along a length of the input tray 108 and the input extension 106. As shown, the tracks 124 extend linearly from the back side 122 of the input tray 108 to a terminal end 126 of the input extension 106. The tracks 124 formed along the input assembly 102 as indicated are configured to engage with respective tracks of the feed compartment 103 of the printer and other components, as further described herein.

The input tray 108 defines a surface 130, and the tracks 124 extend along the surface 130 from the back side 122 of the input tray 108 along the input extension 106 to the terminal end 126 as indicated. In addition, a perimeter wall 132 (designated portion 132A, portion 132B, and portion 132C) is defined along edges of the surface 130 of the input tray 108 as shown. The perimeter wall 132 maintains the documents fed to the printer 101 in a fixed position during a print job. As further shown, an edge 134 of the input tray 108 is devoid of the perimeter wall 132 along the front side 120. The edge 134 engages with the feed compartment 103 of the printer 101 as further described herein.

In some embodiments, the input assembly 102 further includes a paper stop 136 mounted along the plurality of tracks 124 as shown in FIGS. 3A-3C. More specifically, the paper stop 136 defines a generally planar base portion 138 engaged to the plurality of tracks 124, and a stop portion 140 in communication with the base portion 138. The paper stop 136 is mounted to and rests along a desired position of the plurality of tracks 124 to accommodate different sized documents as further described herein. As indicated in FIG. 3D, the paper stop 136 may include an adjustment mechanism 142 defining a locking member 144 housed within the stop portion 140 and operatively engaged to a mating block 146 defined along a bottom edge of the stop portion 140. In operation, the locking member 144 may define a screw-type fastener, and twisting the locking member 144 in a clock-wise or counter clock-wise direction moves the mating block 146 towards or away from the surface 130, to lock the paper stop 136 along the plurality of tracks 124 or to free the paper stop 136 for adjustment as desired.

In some embodiments as shown in FIG. 3D, the paper stop 136 includes predetermined structural characteristics 147 such as one or more indentations or notches formed along the stop portion 140. The notches or indentations permit the paper stop 136 to clear structure present within the printer 101 when the paper stop 136 traverses the plurality of tracks 124 to a position within a base housing 150 defined by the printer (FIG. 3F) or effectively within the printer 101. In addition, as shown, an opening 148 may be formed along the base portion 138. The opening 138 may be leveraged to view predetermined markings formed along the input extension 106 and the input tray 108 to guide positioning of the paper stop 136 to a particular position suitable for maintaining a particular sized document.

FIGS. 3E-3G illustrate further details regarding the engagement of the input assembly 102 to the printer 101. As indicated in FIG. 3E, the feed compartment 103 is typically positioned along the bottom of the printer 101 as shown. The feed compartment 103 may be temporarily removed in FIG. 3F to expose a base housing 150 of the printer 101. The base housing 150 of the printer 101 is limited by the dimensions of the feed compartment 103; i.e., the base housing 150 is not large enough to receive certain documents such as various elections documents.

Referring to FIG. 3G, once the feed compartment 103 is temporarily removed from the printer 101, the edge 134 of the input tray 108 is oriented towards and aligned with a respective edge 152 of the feed compartment 103, and the input extension 106 is engaged to respective tracks 154 of the feed compartment 103 in the manner shown to align the tracks 124 and the tracks 154, and effectively connect the input assembly 102 to the feed compartment 103. The connection between the input assembly 102 and the feed compartment 103 further forms a larger housing 160 between the back side 122 of the input tray 108 and a respective back side 162 of the feed compartment 103; the housing 160 is larger than the housing 150 and configured to receive and feed larger predetermined documents such as elections documents. In addition, the paper stop 136 can be adjusted to a position over the feed compartment 103 to feed smaller documents as desired. In addition, the feed compartment 103, connected to the input assembly 102 as described, can be repositioned along the bottom of the printer 101 in the configuration shown in FIG. 1A. As such, the input assembly 102 provides various improvements to the printer 101 with respect to flexibility and efficiency. In some embodiments, the input extension 106 is glued to the input tray 108, or such components may be manufactured as one single piece.

Referring to FIGS. 3H-3I, in some embodiments, the input assembly 102 is further configured to connect with the feed compartment by leveraging a latch 163 defined along the feed compartment as indicated. For example, the input extension 106 may include a notch 164 formed along a bottom side of the input extension 106, opposite the surface 130. The notch 164 is configured to receive the latch 163, to lock the input assembly 102 in place relative to the feed compartment 103 of the printer 101, as depicted in the configuration shown in FIG. 3G.

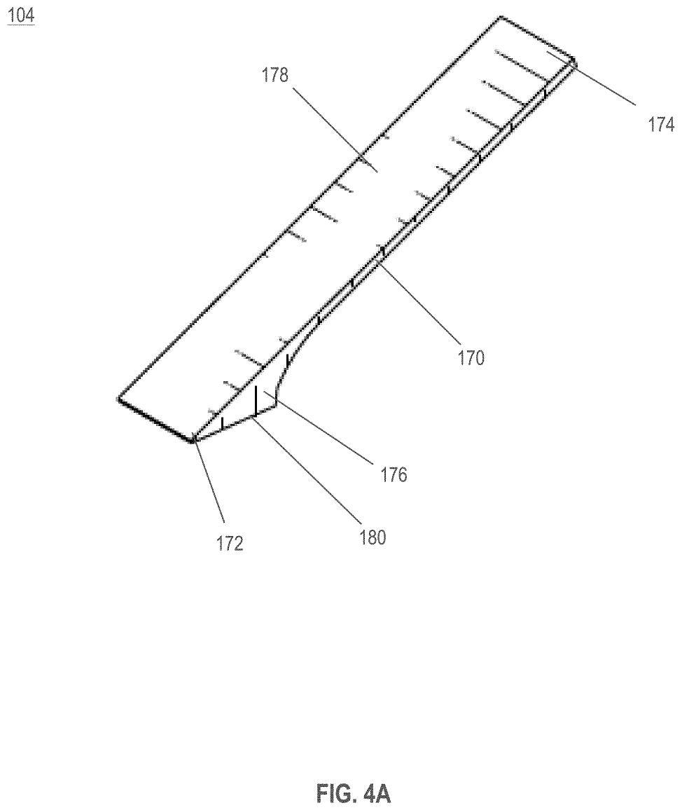

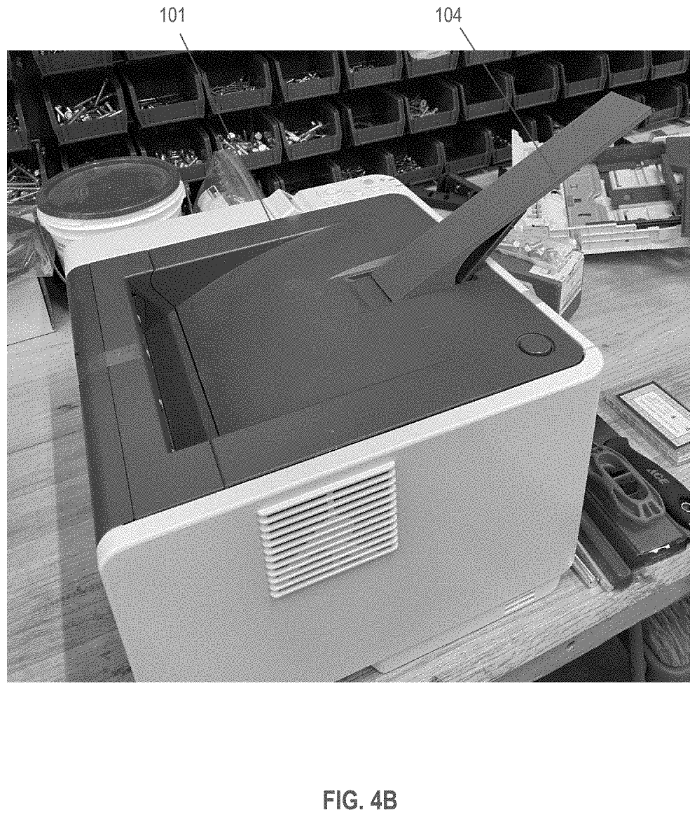

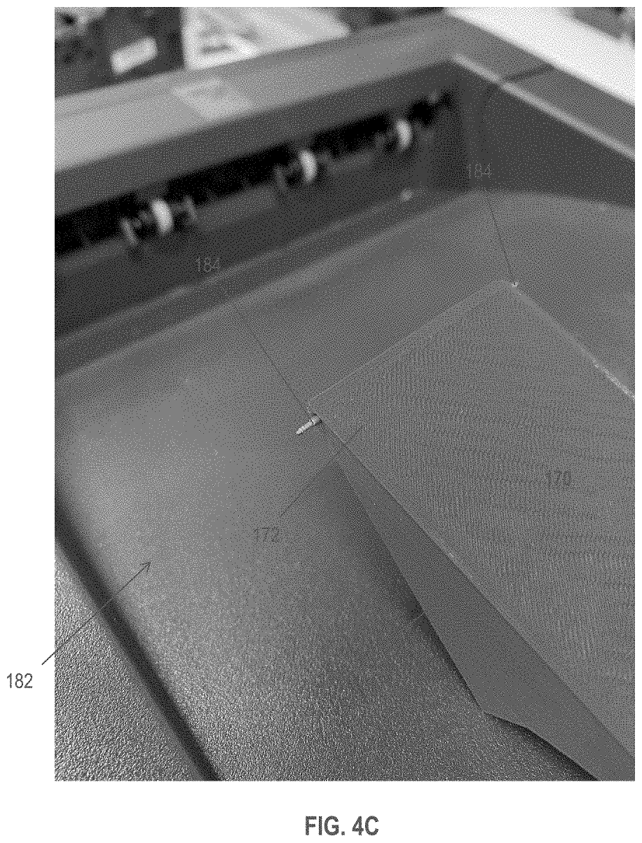

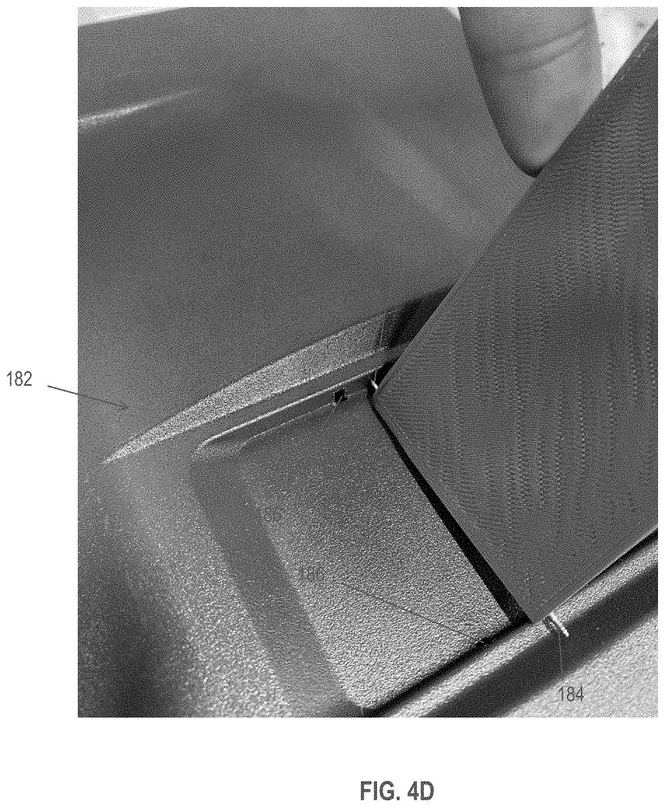

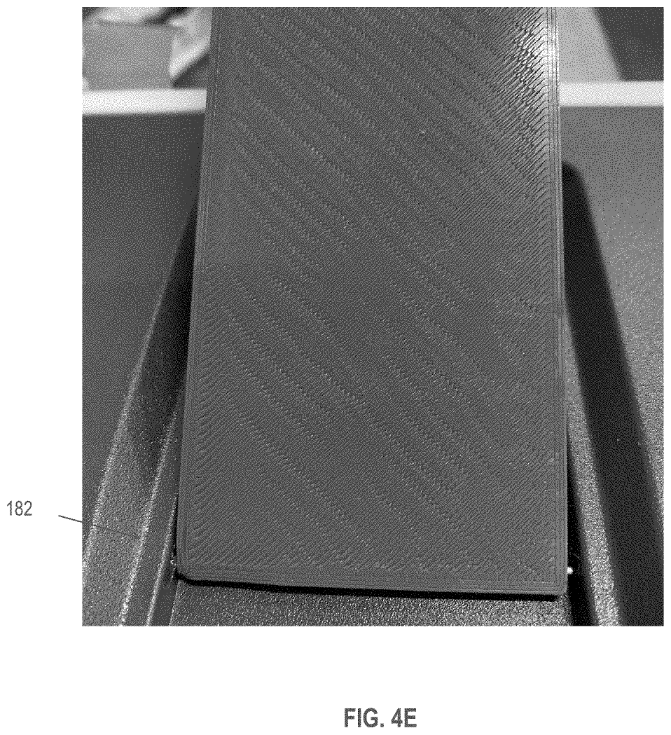

Referring to FIGS. 4A-4E, additional details regarding the output assembly 104 of the system 100 and engagement to the printer 101 are illustrated. As shown in FIG. 4A, embodiments of the output assembly 104 include a delivery extension 170, defining a connection end 172 configured for connection to the printer 101, and a free end 174 opposite the connection end 172. The delivery extension 170 includes a connection portion 176 defined along the connection end 172 which generally has additional structure to facilitate engagement of the connection end 172 of the delivery extension 170 to the printer 101 as further described herein. The connection portion 176 is in communication with a resting portion 178 which extends from the connection portion 176 to the free end 174. As indicated, a planar bottom edge 180 of the connection portion 176 intersects the connection end 172 at an angle, such that the free end 174 is inclined at an angle away from the bottom edge 180. A final engagement position and configuration of the output assembly 104 to the printer is shown in FIG. 4B.

FIGS. 4C-4E illustrate a connection mechanism 182 according to some embodiments of the system 100 configured for mounting the output assembly 104 to the printer 101. As indicated in FIG. 4C, the connection mechanism 182 includes a pair of spring bars 184 pressed into the delivery extension 170 along the connection end 172. As indicated in FIG. 4D, the spring bars 184 are temporarily depressed or compressed and received within respective openings 186 formed along the printer 101. Once received within the openings 186, the spring bars 184 return to a normal decompressed configuration, locking the delivery extension 170 in a fixed position relative to the printer 101, as indicated in FIG. 4E. As indicated in FIG. 4B, the output assembly 104 may simply abut a stock output member of the printer 101, saving time and increasing efficiency.

Referring to FIG. 4, method or process 1000 is shown for forming the input assembly 102 and the output assembly 104 described herein. As indicated in block 1001, parameters associated with a printer needing modification can first be accessed (by a processing element or otherwise). Parameters may include, by non-limiting examples, dimensions of the printer such as a width and depth of the feed compartment 103, so that the input tray 108 can be formed with suitable dimensions for engaging with the printer as described herein. As indicated in blocks 1002-1003, the output assembly 104 can be similarly formed to accommodate dimensions specific to a particular printer.

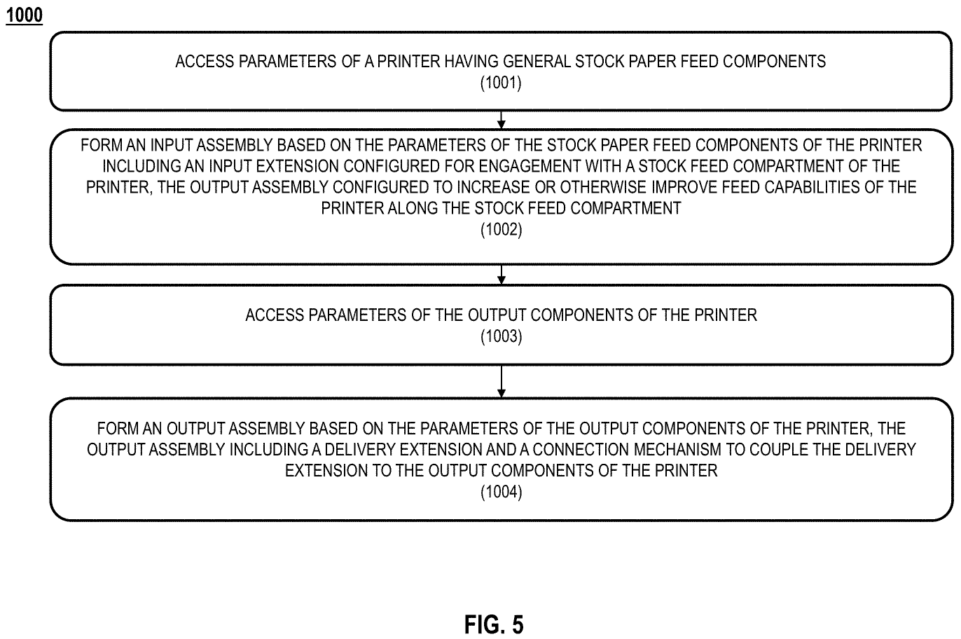

Referring to FIG. 5, a method or process 1100 is shown for modifying a printer using the input assembly 102 and the output assembly 104, and executing a print job. As indicated in blocks 1101-1105, an input assembly 102 formed as described by the process 1000 and/or as described herein can be mounted to a printer by engaging the tracks 124 of the input assembly 102 with respective tracks of a (stock) feed compartment 103 of the printer. For example, a convention input tray of the printer can be removed, and the input assembly 102 can be positioned along the printer where the conventional input tray was initially positioned. The input assembly 102 may include a paper stop 136 including an adjustment mechanism 142 that can allow the paper stop 136 to be adjusted along a length of the input tray 108 in a desired position, based upon, e.g., a predetermined document configuration. As further illustrated, the output assembly 104 as described herein can be engaged to the printer, and the printer can be implemented to execute a print job with the enhanced capabilities provided by the input assembly 102 and the output assembly 104 described herein.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for modifying a printer, comprising:
an input assembly that modifies a printer to feed predetermined documents to the printer for a print job, including:
an input tray including a perimeter wall extending along a back side and along lateral sides of the input tray, and a plurality of tracks defined along a surface of the input tray;
an input extension extending from the input tray, the plurality of tracks extending from the input tray along the input extension; and
a paper stop, the paper stop adjustable to a fixed position along the plurality of tracks,
wherein the input assembly is configured for connection with a feed compartment of a printer to form a housing configured to receive and feed the predetermined documents.

2. The system of claim 1, further comprising a notch formed along a bottom side of the input extension, the notched configured to receive and engage a latch formed along the feed compartment of the printer to further lock the input assembly in a fixed position relative to the feed compartment.

3. The system of claim 1, further comprising an adjustment mechanism defined along the paper stop, the adjustment mechanism including a locking member in operable connection with a mating block, the locking member adjustable to move the mating block into contact with the surface of the input tray to lock the paper stop in a fixed position along the plurality of tracks of the input assembly.

4. The system of claim 1, wherein the plurality of tracks extend linearly from the back side of the input tray to a terminal end of the input extension and align with respective tracks of the feed compartment of the printer.

5. The system of claim 1, wherein an edge of the input tray is devoid of the perimeter wall along the front side of the input tray and the input extension extends from a centermost portion of the edge, the edge configured to engage with the feed compartment of the printer.

6. The system of claim 1, further comprising:
an output assembly that engages to the printer for securing the predetermined documents after the print job, the output assembly including a delivery extension that guides the predetermined documents to a resting position after printing.

7. The system of claim 6, further comprising:
a delivery extension of the output assembly defining a connection end and a free end, the delivery extension including:
a connection portion defined along the connection end, and a resting portion in communication with the connection portion and extending to the free end, the free end inclined at an angle away from a bottom edge of the connection portion.

8. The system of claim 7, further comprising:
a connection mechanism including a pair of spring bars pressed into the delivery extension along the connection end, the spring bars configured to be received within respective openings of the printer to lock the output assembly in place along the printer.

9. The system of claim 1, wherein the predetermined documents include elections documents that the printer would not be capable of feeding without the input assembly.

10. A system, comprising:
an input assembly that modifies a printer to feed predetermined documents to the printer for a print job, including:
an input tray including a plurality of tracks defined along a surface of the input tray; and
an input extension extending from the input tray, the plurality of tracks extending from the input tray along the input extension,
wherein the input assembly is configured for connection with a feed compartment of a printer to form a housing configured to receive and feed the predetermined documents.

11. The system of claim 10, further comprising:
an output assembly that engages to the printer for securing the predetermined documents after the print job, the output assembly including a delivery extension that guides the predetermined documents to a resting position after printing.

12. A method, comprising:
forming an input assembly that modifies a printer to feed predetermined documents to the printer for a print job, including:
forming an input tray including:
providing a substrate,
forming a perimeter wall extending along a back side and along lateral sides of the substrate, and
forming a plurality of tracks along a surface of the substrate; and
coupling an input extension along the input tray, the plurality of tracks extending from the substrate along the input extension,
wherein the input assembly is configured for connection with a feed compartment of a printer to form a housing configured to receive and feed the predetermined documents.

13. The method of claim 12, further comprising:
forming an elongated member defining an output assembly that engages to the printer for securing one or more predetermined documents, the elongated member including a delivery extension defining a connection end configured for connection to the printer, and a free end opposite the connection end, the delivery extension configured to guide the predetermined documents to a resting position after printing.

14. The method of claim 12, further comprising:
engaging the plurality of tracks of the input assembly over respective tracks of the feed compartment of the printer to mount the input assembly to the feed compartment of the printer.

15. The method of claim 12, further comprising:
mounting a paper stop including a locking member along the input tray, and
adjusting the locking member of the paper stop to a desired document configuration.
